(19) United States
(12) Patent Application Publication
(10) Pub. No.: US 2019/0323294 A1
(43) Pub. Date: Oct. 24, 2019

(54) EXTENSION OR STRAIGHT LADDER HAVING A RETRACTABLE PLATFORM

(71) Applicant: Louisville Ladder Inc., Louisville, KY (US)

(72) Inventors: Leopoldo VILLEGAS CANTU, Monterrey (MX); Francisco Javier MORENO, Monterrey (MX)

(21) Appl. No.: 15/959,681

(22) Filed: Apr. 23, 2018

(51) Int. Cl. E06C 7/16

(52) U.S. Cl. CPC E06C 7/16

(57) ABSTRACT

A ladder has a pair of side rails in generally parallel relationship, a plurality of rungs extending between the pair of side rails, and a platform pivotally mounted to the pair of side rails. The platform is movable between a retracted position generally adjacent to said pair of side rails and an extended position extending outwardly of the pair of side rails. A first line has one end affixed to one side of the platform and an opposite end affixed to one of the pair of side rails. In particular, the ladder is an extension ladder having a fly section and a base section. The platform is pivotally mounted to the fly section. The platform moves to the extended position when the fly section slides longitudinally outwardly of the base section or vice versa.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to ladders. More particularly, the present invention relates to platforms as used with the ladders. In particular, the present invention relates to ladders that have the platform pivotally mounted thereto so that the platform can support a worker thereon.

### 2. Description of Related Art Including Information Disclosed Under 37 CFR 1.97 and 37 CFR 1.98

Ladders are commonly used for a variety of applications and are of two general types. One type is a folding ladder, commonly called a stepladder, which is self-supporting. Stepladders are typically used for such tasks as pruning, painting, sealing or other similar tasks where it may be impossible to lean the ladder against a structure for support. Stepladders typically have wide, flat rungs which enhance the stability and comfort when climbing or standing on the ladder.

The other type of ladder which is well known is the straight extension ladder. This type of ladder is simply leaned against a wall or some other structure when standing or climbing on the ladder. These ladders often include a fly section which can be used to telescopically extend the length of the ladder as desired.

FIG. 1 shows a prior art extension ladder 10. The extension ladder 10 includes a fly section 12 and a base section 14. The fly section 12 and the base section 14 are slidable in relationship to each other. A plurality of rungs 16 are affixed to the fly section 12. Another plurality of rungs 18 are affixed to the base section 14. The fly section 12 includes a pair of side rails 20 and 22 that are in generally parallel relationship to each other. The rungs 16 extend between the pair of side rails 20 and 22. Similarly, the base section 14 has side rails 24 and 26. The plurality of rungs 18 extend between the pair of side rails 24 and 26. A rope and pulley system 28 is secured between the fly section 12 and the base section 14. The rope 30 wraps around the pulley 28 so as to secure the fly section 12 in a desired position relative to the base section 14. A rung lock 32 affixes the fly section 12 to the base section 14 in the extended position. Anti-slip safety shoes 34 are affixed to each of the side rails 24 and 26 of the base section 14 so as to prevent the base section 14 from sliding relative to an underlying surface.

As can be seen in FIG. 1, the fly section 12 has relatively narrow diameter rungs 16. As the fly section 12 is extended outwardly from the base section 14, the worker must support himself or herself upon these relatively narrow diameter rungs 16. Since the rungs are generally round or ovoid, there is a relatively small surface area of contact between the feet of the worker and the rung 16. Additionally, when the workers supports himself upon these rungs 16, the weight of the worker will generally be located on the outside of the fly section 12 away from the surface upon which the ladder is supported. As a result, the worker will have to reach further in order to accomplish the desired task on the inner side of the ladder 10. As such, a need has developed so as to provide a wider surface area for the feet of the worker on the fly section 12. This needs to be accomplished while still allowing the fly section 12 to move longitudinally outwardly and inwardly with respect to the base section 14

In the past, various patents have issued with respect to extension ladders. For example, U.S. Pat. No. 5,117,943, issued on Jun. 2, 1992 to Schmidt et al., provides a rung lock assembly for an extension ladder. The rung lock assembly selectively and releasably locks a pair of adjacent rungs of the relatively slidable fly ladder and the base ladder sections of an extension ladder. The rung lock assembly includes a rung lock frame pivotally mounted within the fly ladder section so as to be normally urged into engagement with adjacent rungs of the ladder section. A pulley and cable system is cooperative with the rung lock frame to release and move the rung lock frame away from engagement for relative slidable movement of the ladder sections.

U.S. Pat. No. 5,590,739, issued on Jan. 7, 1997 to Hagh et al., discloses an adjustable extension ladder that has a main and upper riser section extendable by motor. The ladder further includes a telescopic prop so that the ladder may be freestanding. Side wing legs are provided for stabilizing the ladder and wheels are provided for transporting the ladder.

U.S. Pat. No. 5,941,343, issued on Aug. 24, 1999 to D. Kelsey, teaches a safety extension accessory for ladders having laterally-spaced rails. The rails are interconnected by laterally extending rungs. The safety accessory includes a pair of handrails each having an upper portion and a lower portion. Each lower portion is affixed to the upper portion of the respective ladder rail. A non-skid base is provided on the lower portion of the handrails to engage the landing surface. The handrails are spaced apart further than the ladder rails to permit easy entry to the landing surface through the handrails.

U.S. Pat. No. 5,967,260, issued on Oct. 19, 1999 to G. E. Spack, discloses a full-length stepladder with large, fold-away steps. The steps are independently and individually foldable and are deep recessed into the fold-down position so that a person standing on the ladder can lean into and between the ladder frame defined by front and rear side rails. This allows the worker to reach closer, with less obstruction and likelihood of injury, to the adjacent vertical wall or work object. Each step is supported upon the side rails of the ladder by an extension arm and a pair of right-angle flanges attached a respective side rails of the ladder frame. The flange bracing allows for support of over-sized steps.

It is an object of the present invention to provide a ladder assembly that automatically closes and opens a platform on a straight or extension ladder.

It is another object of the present invention provide a ladder assembly that has increased foot surface contact.

It is another object of present invention to provide a ladder assembly that provides a more comfortable working environment for the worker.

It is another object of the present invention provide a ladder assembly that is safer.

It is further object of the present invention to provide a ladder assembly that improves the center-of-gravity of the worker on the fly section of the extension ladder.

It is another object of the present invention to provide a ladder assembly that is easier to store.

It is a further object of the present invention provide a ladder assembly that is easy to manufacture, relatively inexpensive, and easy-to-use.

These and other objects and advantages of the present invention will become apparent from a reading of the attached specification and appended claims.

### BRIEF SUMMARY OF THE INVENTION

The present invention is a ladder assembly that comprises a pair of side rails extending in generally parallel relation, a plurality rungs extending between the pair of side rails, and a platform pivotally mounted to the pair of side rails. The platform is movable between a retracted position generally between the pair of side rails and an extended position extending outwardly of the pair of side rails.

The platform is pivotally mounted to the pair of side rails adjacent to one of the plurality of rungs. The platform has a generally planar top surface. The platform has sides extending downwardly in transverse relationship to the generally planar surface. The sides extend from a periphery of the top surface.

A first line has one end affixed to one side of the platform and an opposite end affixed to one of the pair of side rails. A second line has one end affixed to an opposite side of the platform and opposite end affixed to another of the pair of side rails. Each of the first and second lines can be either a chain, a wire, a string, or a pivot member.

In the present invention, there is a base section that is secured in slidable relation to the pair of side rails. The base section has a plurality of rungs extending between a pair of sides. The base section is slidable along the pair of side rails in one direction so as to move the platform to the retracted position and slidable in an opposite direction so as to as to move the platform to the extended position. The platform moves to the extended position when the base section slides longitudinally outwardly of the pair of side rails. At least one of the plurality rungs of the base section abuts the platform so as to retain the platform in the retracted position. The plurality of rungs of the base section are slidable along any underside of the platform.

In the present invention, the platform comprises a plurality of platforms pivotally attached to a pair of side rails. The plurality of platforms are arranged in spaced relation to each other. The plurality of side rails have an outer side and an inner side. The platform extends outwardly of the inner side when the platform is in the extended position. The pair of side rails has a stop thereon. The stop abuts and secures the platform in the retracted position.

The present invention is also an extension ladder that comprises a base section having a pair of sides and a plurality of rungs extending between the pair of sides, and a fly section slidably mounted to the base section. The fly section is movable between a retracted position and extended position. The fly section includes a pair of side rails extending a generally parallel relation, a plurality of rungs extending between the pair of side rails, and a platform pivotally mounted to the pair of side rails. The platform is movable between a retracted position generally between and adjacent to the pair of side rails and an extended position extending outwardly of the pair of side rails.

In the extension ladder the present invention, a first line has one end affixed to one side of the platform and an opposite end affixed to one of the pair of side rails. A second line has one end affixed to an opposite side of the platform and an opposite end affixed to another of the pair of side rails. The base section is slidable along the fly section in one direction so as to move the platform to the retracted position and slidable in an opposite direction so as to move the platform to the extended position. The platform moves to the extended position when the base section slides longitudinally outwardly of the fly section. The platform includes a plurality of platforms that are pivotally mounted to the fly section in spaced relationship to each other. The fly section has an outer side and inner side. The platform extends outwardly of the inner side when the platform is in the extended position.

This foregoing Section is intended to describe, with particularity, the preferred embodiments of the present invention. This Section is not intended to describe, in any way, the broad scope of the present invention. The present inventions should only be limited by the following claims and their legal equivalents.

### BRIEF DESCRIPTION OF THE SEVERAL VIEWS OF THE DRAWINGS

FIG. 1 is a perspective view showing a prior art extension ladder.

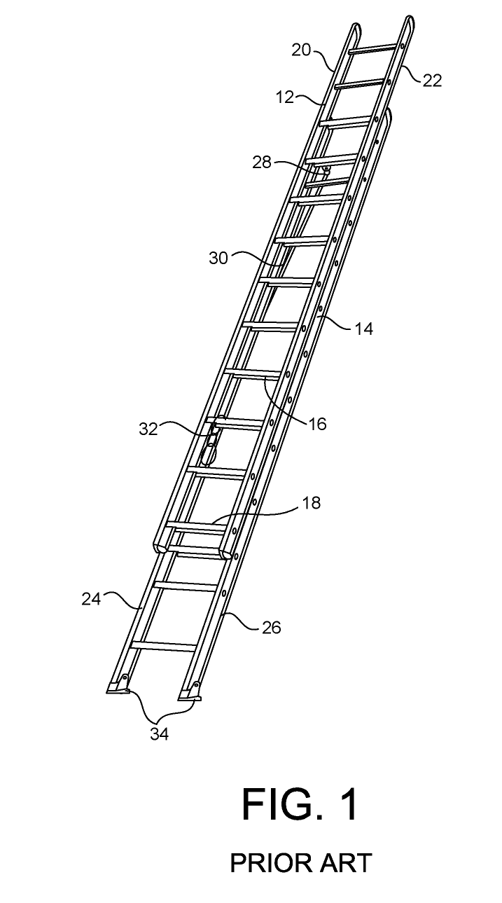

FIG. 2 is a perspective view of the ladder assembly in accordance with the present invention.

FIG. 3 shows a side elevational view of the fly section of the present invention with the platform in its extended configuration.

FIGS. 4A-4C shows the platform as moving between a retracted position and an extended position relative to the movement of the fly section with respect to the base section of the ladder assembly.

### DETAILED DESCRIPTION OF THE INVENTION

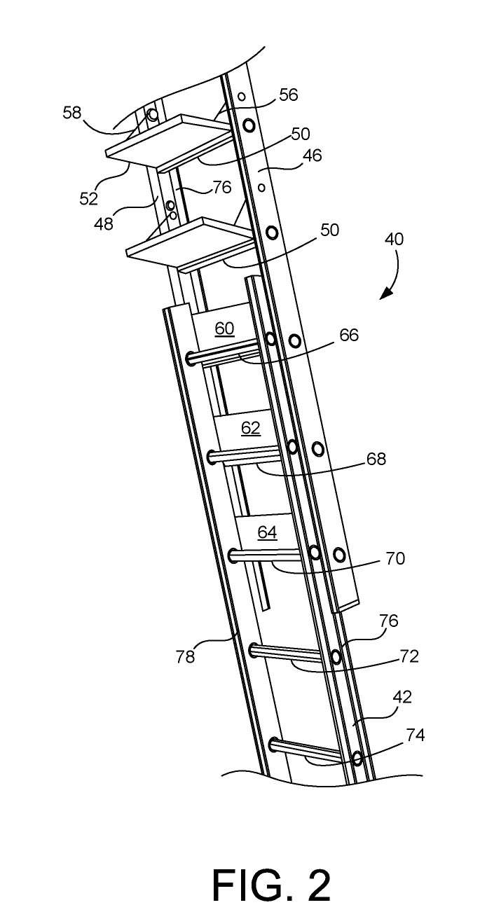

Referring to FIG. 2, there is shown the ladder assembly 40 of the present invention. The ladder assembly 40 includes a base section 42 and a fly section 44. The fly section 44 is slidably mounted to the base section 42. As such, the fly section 44 can be movable between a retracted position and an extended position. The fly section 44 of the ladder assembly 40 includes a pair of side rails 46 and 48 that extend in generally parallel relationship to each other. A plurality of rungs 50 extend between the pair of side rails 46 and 48. A first platform 52 and a second platform 54 are pivotally mounted to the pair of side rails 46 and 48. As will be described hereinafter, each of the platforms 52 and 54 is movable between a retracted position generally between and adjacent to the pair of side rails 46 and 48 and an extended position (as shown in FIG. 2) extending outwardly of the pair of rails 46 and 48. It can be seen that each of the platforms 52 and 54 is pivotally mounted to the pair of side rails 46 and 48 adjacent to the rungs 50.

For each of the platforms 52 and 54, there is a first line 56 that has one end affixed to one side of the platform and an opposite end affixed to the side rail 46. A second line 58 has one end affixed to an opposite side of the platform and an opposite end affixed to the side rail 48. Each of the lines 56 and 58 can be either a chain, a wire, a string or a pivot member. The term “pivot member” can refer to a pair of strut that are pivotally mounted to each other so as to generally scissor as the platforms 52 and 54 move from the extended position to the retracted position and vice versa.

In FIG. 2, it can be seen that the platforms 52 and 54 are in the extended position. The fly section 44 further includes platforms 60, 62 and 64 that are illustrated in the retracted position. In this retracted position, the platforms 60, 62 and 64 will extend in a direction generally aligned with or at a slight angle to the longitudinal axis of the fly section 44. The rungs 66, 68 and 70 of the base section 42 bear against the underside of platforms 60, 62 and 64, respectively, so as to retain the platforms 60, 62 and 64 in their retracted position.

The rungs 66, 68, 70, 72 and 74 extend between the sides 76 and 78 of the base section 42. The base section 42 is slidable along the pair of side rails 46 and 48 of the fly section 44 in one direction so as to move the platforms 60, 62 and 64 to the retracted position and slidable in an opposite direction so as to allow the platforms 60, 62 and 64 to pivot, by way of gravity, to the extended position, as are shown by platforms 52 and 54. The platforms 52, 54, 60, 62 and 64 will move to the extended position when the base section 42 slides longitudinally outwardly of the fly section 44. The plurality of rungs 66, 68, 70, 72 and 74 will be slidable along an underside of the respective platforms.

In FIG. 2, it can be seen that there is a stop 76 provided in the side rail 48. Stop 76 will stop the pivotal movement of the respective platforms so as to further retain the platform in its upward and retracted position. The stop 76 keeps the platform from folding all the way over to the other side of the ladder assembly.

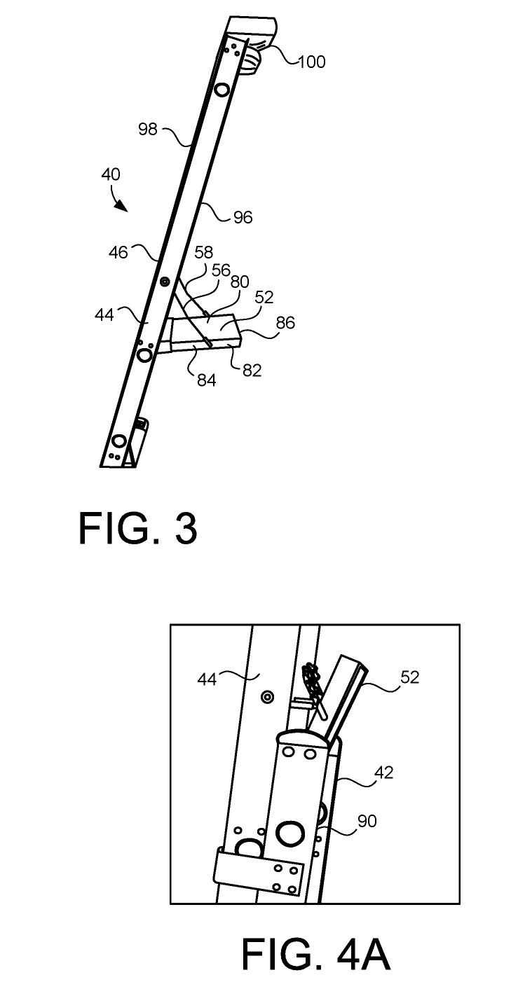

FIG. 3 shows a detailed view of the platform 52 to the ladder assembly 40. Platform 52 has a planar top surface 80 and sides 82 that extend vertically downwardly from the outer periphery of the top surface 80. Since the sides 82 extend transversely of the periphery of the top surface 80, the sides 82 will provide the platform 52 with proper structural integrity so as to support the weight of the worker. Lines 56 and 58 extend from the respective side rails 46 and 48 of the fly section 44 so as to limit the pivotal movement of the platform 52. It can be seen that the lines 56 has one end affixed to the side rail 46 and an opposite end affixed to side 84 of the platform 52. Line 58 is secured to the other side rail 48 and also secured to the opposite side of the platform 52. The attachment of the lines 56 and 58 to the sides of the platform 52 occurs at a location inwardly from the far end 86 of the platform 52 and outwardly of the side rail 46. The central placement of the connection of the lines 56 and 58 serves to avoid any interference with the movement of the worker's foot on the platform 52 while, at the same time, enhancing the structural strength of the support of the platform 52.

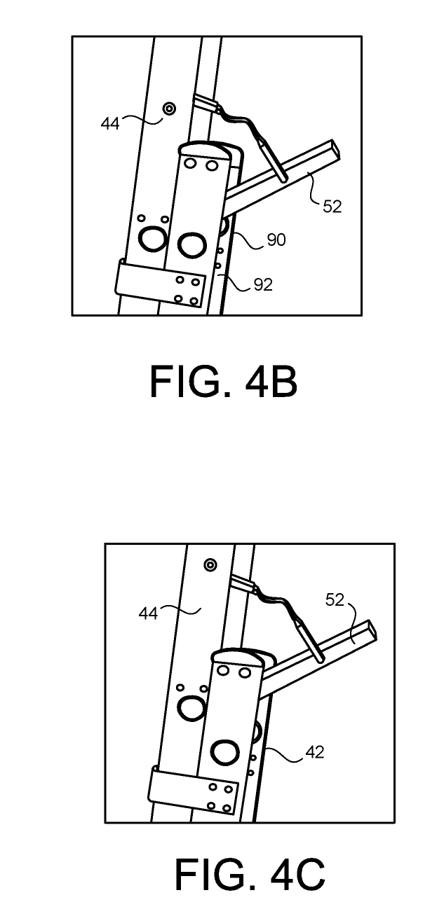

FIGS. 4A-4C show the movement of the platform 52 relative to the movement of the fly section 44 with respect to the base section 42. In FIG. 4A, the fly section 44 is moved downwardly. The rung 90 will bear against the underside of the platform 52 so as to pivot the platform 52 upwardly so that, ultimately, it can reside between the rails of the fly section 44. FIG. 4B shows that the base section 42 is moved downwardly with respect of the fly section 44. As such, the rung 90 will allow the platform 52 to pivot downwardly. FIG. 4C shows that the fly section 44 is moved further upwardly with respect to the fly section 44. As a result, the platform 52 can move to its outer or extended position. Ideally, the platform 52 will allow the foot of the worker to extend in a generally horizontal orientation with respect to the ladder assembly. As such, the platform 52 will generally extend at less than 90° with respect to the fly section 44.

With reference to FIG. 3, it can be seen that the ladder assembly 40 has an inner side 96 and an outer side 98. The top plate 100 is located at the upper end of the side rails 46 and 48 so as to allow the ladder assembly 42 bear against an extrinsic surface. In normal use, the worker will work in area adjacent to the inner side 96 of the ladder assembly 40. Importantly, in the present invention, platform 52 extends outwardly of the fly section 44 on the inner side 96 of the ladder assembly 40. As such, when standing on the platform 52, the worker will be closer to the area at the inner side of the top plate 100 and closer to the work surface. This allows easier access of the worker to the work area. Furthermore, since the worker is has his or her weight positioned on the platform 52 on the inner side 96 of the ladder assembly 40, the center-of-gravity of the worker will be closer to where it should be relative to the ground surface or other underlying surface. This will further enhance the stability of the ladder assembly 40. Since the platform 52 has a planar top surface 80, the feet of the worker will be supported on a natural flat surface, rather than the round or ovoid surfaces of conventional rungs. As such, the worker will experience greater comfort over an extended period of time. The planar top surface 80 of the platform 52 also provides the worker with a wider foot contact surface so as to further enhance the stability of the worker on the ladder assembly 40. This will provide greater safety and comfort to the worker. Since the platform 52, along with the other platforms, will be generally folded into the area between the side rails of the fly section 44, the ladder assembly 40 can be conveniently stored when the fly section 44 is retracted into the base section 42. The pivotability of the platform 52 with respect to the fly section 44 will not interfere, in any way, with the movement of the fly section 44 with respect to the base section 42. The pivotable relationship between the platform 52 and the fly section 44 allows the platform 52 to drop naturally by way of gravity. The use of the lines 56 and 58 causes the platform 52 to be maintained in a generally parallel relationship to the underlying surface of the ladder. As a result, the worker will stand in a natural horizontal position.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

1. An extension ladder comprising:
a pair of side rails extending in a generally parallel relationship;
a plurality of rungs extending in spaced relation between said pair of side rails;
a plurality of platforms pivotally mounted to said pair of side rails, said plurality of platforms being movable between a retracted position generally aligned with said pair of side rails and an extended position extending outwardly of said pair of side rails; and
a base section secured in slidable relation to said pair of side rails, said base section having a plurality of rungs extending between a pair of sides, said base section slidable along said pair of side rails in one direction so that the plurality of rungs move and retain said plurality of platforms to the retracted position and slidable in an opposite direction to release said plurality of platforms so that said plurality of platforms move by gravity to the extended position, said plurality of rungs of said base section respectively abutting said plurality of platforms so as to retain said plurality of platforms in the retracted position.

2. The extension ladder of claim 1, said platform being pivotally mounted to said pair of side rails adjacent to one of said plurality of rungs.

3. The extension ladder of claim 1, said platform having a generally planar top surface.

4. The extension ladder of claim 3, said platform having sides extending downwardly in transverse relationship to said generally planar top surface, the sides extending from a periphery of said top surface.

5. An extension ladder comprising:
a pair of side rails extending in a generally parallel relationship;
a plurality of rungs extending in spaced relation between said pair of side rails;
a plurality of platforms pivotally mounted to said pair of side rails, said plurality of platforms being movable between a retracted position generally aligned with said pair of side rails and an extended position extending outwardly of said pair of side rails; and
a base section secured in slidable relation to said pair of side rails, said base section having a plurality of rungs extending between a pair of sides, said base section slidable along said pair of side rails in one direction so that the plurality of rungs move and retain said plurality of platforms to the retracted position and slidable in an opposite direction to release said plurality of platforms so that said plurality of platforms move by gravity to the extended position, said plurality of rungs of said base section respectively abutting said plurality of platforms so as to retain said plurality of platforms in the retracted position;
a first line having one end affixed to a center of one side of said platform and an opposite end affixed to one of said pair of side rails; and
a second line having one end affixed to a center of an opposite side of said platform and an opposite end affixed to another of said pair of side rails, each of said first and second lines selected from the group consisting of a chain, a wire, a string, and a pivot member.

6. (canceled)

7. (canceled)

8. (canceled)

9. (canceled)

10. (canceled)

11. The extension ladder of claim 1, said plurality of rungs of said base section being slidable along an underside of said plurality of platforms.

12. (canceled)

13. The extension ladder of claim 11, said pair of side rails having an outer side in an inner side, said plurality of platforms extending outwardly of said inner side when said plurality of platforms are in the extended position.

14. The extension ladder of claim 1, said pair of side rails having a plurality of stops thereon, said plurality of stops abutting said plurality of platforms in the retracted position so as to retain said plurality of platforms in the retracted position.

15. An extension ladder comprising:
a base section having a pair of sides and a plurality of rungs extending between said pair of sides; and
a fly section slidably mounted to said base section, said fly section movable between a retracted position and an extended position, said fly section comprising:
a pair of side rails extending in generally parallel relationship;
a plurality of rungs extending between said pair of side rails; and
a platform pivotally mounted to said pair of side rails, said platform being movable between a retracted position generally aligned with said pair of side rails and an extended position in which an end of said platform extends outwardly of said pair of side rails, said fly section slidable along said base section in one direction such that at least one of said plurality of rungs of said fly section moves and retains said platform to the retracted position and slidable in an opposite direction so as to cause said platform to move by gravity to the extended position.

16. The extension ladder of claim 15, further comprising:
a first line having one end affixed to one side of said platform and an opposite end affixed to one of said pair of side rails; and
a second line having one end affixed to an opposite side of said platform and an opposite end affixed to another of said pair of side rails.

17. (canceled)

18. The extension ladder of claim 15, said platform moving to the extended position when said fly section slides longitudinally outwardly of said base section.

19. The extension ladder of claim 15, said platform comprising a plurality of platforms pivotally attached to said fly section in spaced relation to each other.

20. The extension ladder of claim 15, said fly section having an outer side and inner side, said platform extending outwardly of said inner side when said platform is in the extended position.
